(19) United States
(12) Patent Application Publication
(10) Pub. No.: US 2018/0181456 A1
(43) Pub. Date: Jun. 28, 2018

(54) INTERNET OF THINGS FRAMEWORK AND METHOD OF OPERATING THE SAME

(71) Applicant: Samsung Electronics Co., Ltd., Suwon-si (KR)

(72) Inventor: Yang-Su KIM, Suwon-si (KR)

(21) Appl. No.: 15/815,903

(22) Filed: Nov. 17, 2017

(30) Foreign Application Priority Data
Dec. 26, 2016 (KR) 10-2016-0178987

(51) Int. Cl. G06F 11/07; G06F 11/14; G06F 9/50

(52) U.S. Cl. CPC G06F 11/0709; G06F 11/1484; G06F 9/45558; G06F 9/5027; G06F 11/0766

(57) ABSTRACT

A method of operating an IoT system that includes a first test system including a first test server and a first test device group, a second test system including a second test server and a second test device group, and a main server, where the first test system, the second test system, and the main server are connected through a network, is provided. According to the method, a virtual machine for performing a test on a test target using a test case is created based on at least a portion of resources of the first test device group and resources of the first test server, at least one test device that is to be interconnected with the virtual machine is selected among the first test device group and the second test device group, and the test is performed using the virtual machine and the at least one test device.

### CROSS-REFERENCE TO RELATED APPLICATION(S)

This application claims priority under 35 USC § 119 to Korean Patent Application No. 10-2016-0178987, filed on Dec. 26, 2016 in the Korean Intellectual Property Office (KIPO), the contents of which are incorporated herein in its entirety by reference.

### BACKGROUND

### 1. Technical Field

Example embodiments relate generally to an internet of things (IoT) framework. More particularly, embodiments of the present inventive concept relate to an IoT framework that performs a test on IoT software and/or IoT hardware and a method of operating the IoT framework.

### 2. Description of the Related Art

An internet of things (IoT) technology is a technology that provides a user-centered intelligent service by performing a connection between a user and a thing and a connection between things. As the IoT technology is being developed, IoT products (e.g., IoT software and IoT hardware) are being diversified, the international standard and the verification procedure for the IoT products are being complicated, and the verification scenario for the IoT products is being diversified to satisfy high expectation of the user. Recently, a framework for quickly performing complex and various verifications on the IoT products has been suggested. However, since the framework uses limited resources, there are limits to reduce a verification time for the IoT products.

### SUMMARY

Some example embodiments provide an internet of things (IoT) framework/system that can reduce a verification time for IoT products.

Some example embodiments provide a method of operating an IoT framework/system that can improve efficiency of the IoT framework.

According to an aspect of example embodiments, a method of operating an IoT system that includes a first test system including a first test server and a first test device group, a second test system including a second test server and a second test device group, and a main server, where the first test system, the second test system, and the main server are connected through a network, may include an operation of creating a virtual machine for performing a test on a test target using a test case based on at least a portion of resources of the first test device group and resources of the first test server, an operation of selecting at least one test device among the first test device group and the second test device group, connecting the at least one test device to the virtual machine, and performing the test on the test target using the virtual machine and the at least one test device.

According to another aspect of example embodiments, an IoT system may include a first test system including a first test server and a first test device group, the first test server and the first test device group being connected through a first local network, a second test system including a second test server and a second test device group, the second test server and the second test device group being connected through a second local network, and a main server connected to the first test system and the second test system through a network and configured to manage device information of test devices included in the first test device group and the second test device group. Here, the first test server may create a virtual machine based on at least a portion of resources of the test devices, may select at least one test device based on the device information of the test devices, and may perform a test on a test target using a test case by interconnecting the test target with the at least one test device through the virtual machine.

According to an aspect of example embodiments, a method of operating an IoT system includes: providing a first test system including a first sub server and a first test device group, and connecting the first sub server and the first test device group through a first local network; providing a second test system including a second sub server and a second test device group, and connecting the second sub server and the second test device group through a second local network different from the first local network; and connecting a main server to the first test system and the second test system through a network, the main server managing device information of test devices included in the first test device group and the second test device group; creating a virtual machine based on at least a portion of resources of the test devices and resources of the first sub server; selecting at least one test device based on the device information of the test devices; and performing a test on a test target by interconnecting the test target with the at least one test device through the virtual machine.

Therefore, an IoT framework/system according to example embodiments may reduce a verification time for IoT products by performing a test on the IoT products using test devices located in other locations, which are connected to a main server, as well as test devices connected to a local network.

In addition, a method of operating an IoT framework/system according to example embodiments may improve efficiency of the IoT framework by performing a test on the IoT products based on resources of a test device as well as resources of a test server.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating an internet of things (IoT) framework according to example embodiments.

FIG. 2 is a block diagram illustrating an example of a test server included in the IoT framework of FIG. 1.

FIG. 3 is a block diagram illustrating an example of a test device included in the IoT framework of FIG. 1.

FIG. 4 is a flowchart illustrating a method of operating an IoT framework according to example embodiments.

FIG. 5 is a flowchart illustrating an example in which a test device is searched by the method of FIG. 4.

FIG. 6 is a flowchart illustrating an example in which a virtual machine is generated in a test device by the method of FIG. 4.

### DETAILED DESCRIPTION OF THE EMBODIMENTS

The present disclosure now will be described more fully hereinafter with reference to the accompanying drawings, in which various embodiments are shown. The invention may, however, be embodied in many different forms and should not be construed as limited to the example embodiments set forth herein. These example embodiments are just that—examples—and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention.

Unless the context indicates otherwise, the terms first, second, third, etc., are used as labels to distinguish one element, component, region, layer or section from another element, component, region, layer or section (that may or may not be similar). Thus, a first element, component, region, layer or section discussed below in one section of the specification (or claim) may be referred to as a second element, component, region, layer or section in another section of the specification (or another claim).

As is traditional in the field of the disclosed technology, features and embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of the inventive concepts.

An internet of things (IoT) framework may perform a test on a test target. Here, the test target may include IoT hardware and IoT software. The IoT hardware may include an IoT device constituting IoT, a semiconductor system included in an IoT device, etc. The IoT software may include an operating system (OS), an application, etc that operate in the IoT device. For example, the test target may be a system on chip (SOC) included in the IoT device or the software that operates (or, drives) the system on chip.

The IoT framework may perform a test on the test target using a test case and test devices. Here, the test case may be determined (or, set) based on standard, performance characteristics, etc., required for the test target. In example embodiments, the test case may include test procedures, test contents, etc. For example, the IoT framework may interconnect the test target with at least one of the test devices and may monitor an operation of the test target based on the test procedures and the test contents.

For example, the test case may include an interoperability test and a conformance test. The interoperability test may define test cases based on a scenario to test an end-to-end function between different IoT devices developed based on the same standard (e.g., the IoT devices manufactured by different manufacturers). The IoT framework may perform the interoperability test using a general interface defined by the standard and may test normal operations of the IoT devices.

The conformance test may define test cases for checking whether the IoT devices satisfy requirements (e.g., requirements specified in an oneM2M standard document). For example, the conformance test may include various tests for checking conformance relating to a value of a protocol message, a format, a message exchange procedure, etc. The IoT framework may perform the conformance test using a test interface different from a general interface and may test abnormal operations of the IoT devices as well as normal operations of the IoT devices.

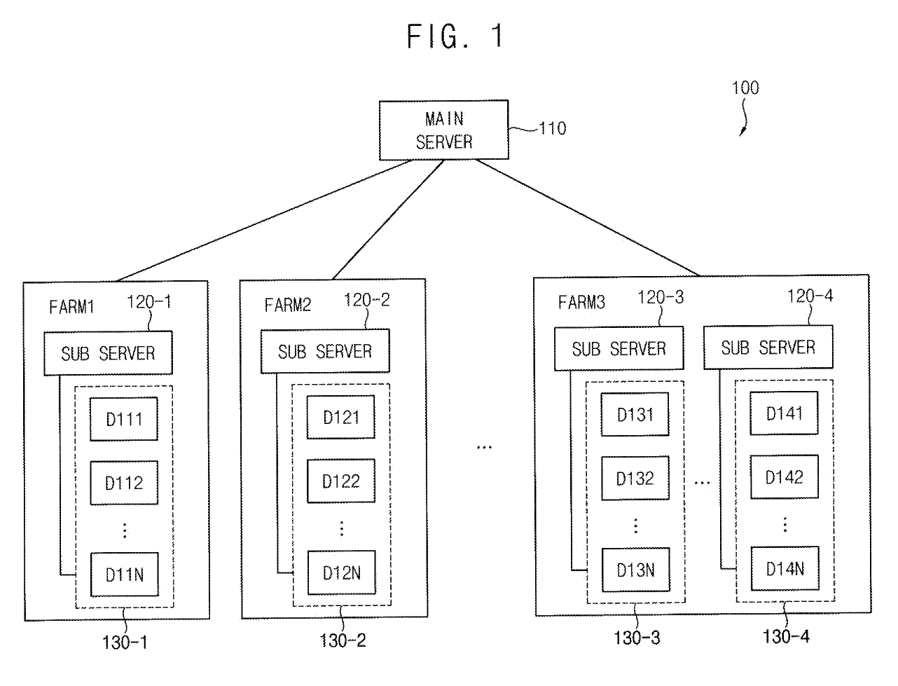

FIG. 1 is a block diagram illustrating an IoT framework and system according to example embodiments.

Referring to FIG. 1, the IoT framework 100 may include a main server 110, a first test system FARM1, a second test system FARM2, and a third test system FARM3. The main server 110 may be connected to the first test system FARM1, the second test system FARM2, and the third test system FARM3, respectively through a network. For example, the first through third test systems FARM1 through FARM3 may be connected to the network or interconnected with each other via the main server 110. Although it is illustrated in FIG. 1 that the IoT framework 100 includes three test systems FARM1 through FARM3, the IoT framework 100 is not limited thereto. For example, the IoT framework 100 may include four or more test systems. A “server” as described herein refers to a hardware and/or software platform that provides data and communications to requesting devices, and may include a standalone computer, a group of networked computers, a portion of a standalone computer, or other network-connected hardware and software. A server may be implemented, for example, on a mainframe computer, Internet service provider computer or computer system, personal computer, laptop computer, or other network-connected computer.

The main server 110 may perform a management function on the first through third test systems FARM1 through FARM3. For example, the main server 110 may store and update information of test devices D111 through D14N included in the first through third test systems FARM1 through FARM3, where N is an integer greater than or equal to 3.

Each of the first through third test systems FARM1 through FARM3 may be a system that is individually constructed to perform a test on a test target. For example, the first through third test systems FARM1 through FARM3 may be constructed in different physical regions.

The first test system FARM1 may include a first test server 120-1 and a first test device group 130-1. The first test device group 130-1 may include N test devices D111 through D11N. For example, the (1)st through (N)th test devices D111 through D11N may be IoT devices. The first test server 120-1 may be located adjacent to the (1)st through (N)th test devices D111 through D11N. The first test server 120-1 may be connected to the (1)st through (N)th test devices D111 through D11N through a first local network. The first test server 120-1 may perform a test on the test target using the first test device group 130-1. For example, the first test server 120-1 may perform the test by interconnecting the test target with the first test device group 130-1. For example, the first test server 120-1 may perform the test by interconnecting the test target with at least one of the (1)st through (N)th test devices D111 through D11N included in the first test device group 130-1. As described herein, a test target refers to a device (e.g., IoT hardware, IoT software, etc) being tested, and a test device refers to a device that can be used to assist in testing the test target.

Similarly, the second test system FARM2 may include a second test server 120-2 and a second test device group 130-2. The second test device group 130-2 may include N test devices D121 through D12N. The second test system FARM2 and the first test system FARM1 may be located in different physical regions. For example, the second test server 120-2 may be connected to the (21)st through (2N)th test devices D121 through D12N through a second local network different from the first local network. The second test server 120-2 may perform a test on a test target using the second test device group 130-2.

The third test system FARM3 may include a third test server 120-3 and a third test device group 130-3. The third test device group 130-3 may include N test devices D131 through D13N. In addition, the third test system FARM3 may include a fourth test server 120-4 and a fourth test device group 130-4. The fourth test device group 130-4 may include N test devices D141 through D14N. The third test system FARM3 may be located in different physical region than each of the first test system FARM1 and the second test system FARM2. For example, the third test server 120-3 may be connected to the (31)st through (3N)th test devices D131 through D13N through a third local network different from the first local network and the second local network. The third test server 120-3 may perform a test on the test target using the third test device group 130-2. The fourth test server 120-4 may be connected to the (41)st through (4N)th test devices D141 through D14N through the third local network. The fourth test server 120-4 may perform a test on the test target using the fourth test device group 130-4.

The first through fourth test servers 120-1 through 120-4 may also be referred to as first through fourth sub servers 120-1 through 120-4. As disclosed herein, the main sever 110 may perform a management function on the first test system FARM1 which includes the first sub server 120-1, perform a management function on the second test system FARM2 which includes the second sub server 120-2, and perform a management function on the third test system FARM3 which includes the third sub server 120-3 and the fourth sub server 120-4. In some example embodiments, the sub servers 120-1, 120-2, 120-3, and 120-4 may perform a management function on the main server 110.

In example embodiments, the first test server 120-1 may create a virtual machine based on resources of the first test server 120-1 and at least a portion of resources of the first test device group 130-1, may select at least one test device (e.g., the (1)st test device D111) based on device information of the (1)st through (N)th test devices D111 through D11N included in the first test device group 130-1 (e.g., available resources, and other information described in greater detail below) and device information of the (21)st through (2N)th test devices D121 through D12N included in the second test device group 130-2, and may perform a test on the test target using a test case (e.g., test procedures, test contents, etc.) by interconnecting the test target with at least one selected test device through the virtual machine. In example embodiments, the resources may include a central processing unit (CPU), a memory device, etc. Since the virtual machine provides a real-time monitoring function, a monitoring result storing function, etc., during a test process, the test may be performed within the virtual machine.

For example, the first test server 120-1 may create the virtual machine based on the resources of the first test device group 130-1 as well as the resources of the first test server 120-1 and may perform the test on the test target using the second test system FARM2 as well as the first test system FARM1. Thus, the IoT framework 100 may minimize (or, reduce) a test delay due to a test device matching delay, a lack of the resources of the first test server 120-1, etc.

As used herein, “IoT” may refer to a network of IoT devices that use wired and/or wireless communication. Accordingly, the IoT may be referred to as an IoT network system, a ubiquitous sensor network (USN) communication system, a machine type communication (MTC) system, a machine-oriented communication (MOC) system, a machine-to-machine (M2M) communication system, or a device-to-device (D2D) communication system. The IoT network system may use a user datagram protocol (UDP), a transmission protocol such as a transmission control protocol (TCP), an IPv6 low-power wireless personal area networks (6LoWPAN) protocol, an IPv6 internet routing protocol, a constrained application protocol (CoAP), a hypertext transfer protocol (HTTP), a message queue telemetry transport (MQTT), or an MQTT for sensors networks (MQTT-S) for exchange (or communication) of information among at least two elements therewithin.

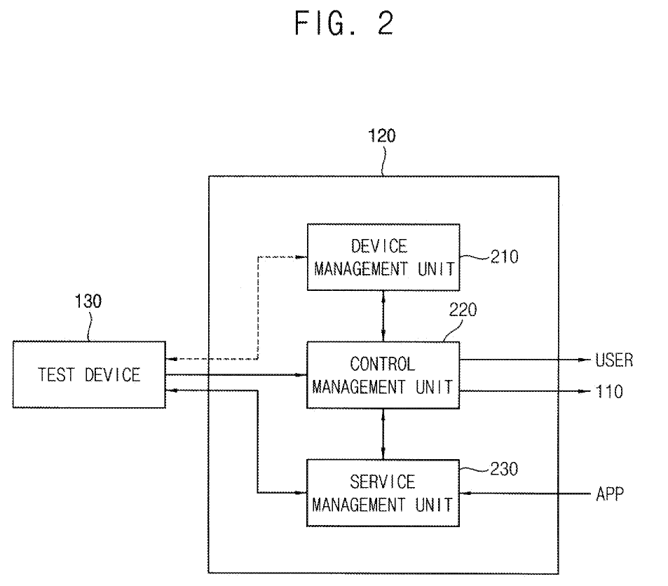

FIG. 2 is a block diagram illustrating an example of a test server included in the IoT framework of FIG. 1.

Referring to FIG. 2, the test server 120 may include a device management unit 210, a control management unit 220, and a service management unit 230. Here, the test server 120 may be substantially identical to the first through fourth test servers 120-1 through 120-4 illustrated in FIG. 1.

The device management unit 210 may perform a function such as a test device managing function, a user managing function, a test device monitoring function, a test device searching function, etc.

The device management unit 210 may receive device information of a test device 130 from a test device provider (or, manufacturer) and may register the test device 130. Here, the test device 130 may be substantially identical or similar to the (1)st through (N)th test devices D111 through D11N, the (21)st through (2N)th test devices D121 through D12N, the (31)st through (3N)th test devices D131 through D13N, and the (41)st through (4N)th test devices D141 through D14N illustrated in FIG. 1. The device information of the test device 130 may include an identity (or, identifier), a product name, a model name, a manufacturer, location information, device state information, etc of the test device 130. In addition, the device information of the test device 130 may include an address (e.g., an IP address) that is used for a connection with the test device 130.

The device management unit 210 may provide the device information of the test device 130 to a user USER (or, an IoT browser, etc) may allow the user USER to search and/or check the test device 130. Similarly, the device management unit 210 may provide the device information of the test device 130 to the main server 110 and may allow the main server 110 or other test servers to search and/or check the test device 130.

The device management unit 210 may perform authentication of the user USER that tries to access the main server 110. For example, the device management unit 210 may include user information such as a user ID, a password PW, a telephone number, etc that are required for the authentication of the user USER. In addition, the device management unit 210 may perform authentication of the user USER that tries to access the service management unit 230 to register or download an application used in the IoT framework (e.g., used to operate or access the test device 130).

The device management unit 210 may monitor a state of the test device 130. For example, the device management unit 210 may determine the state of the test device 130 as an operating state or a non-operating state by monitoring the state of the test device 130 and may store state information indicating the state of the test device 130 in the device information of the test device 130. The device management unit 210 may update the state information according to changes in the state of the test device 130.

The control management unit 220 may create the virtual machine based on resources of the test server 120 and may provide a control command that is output from the virtual machine to the test device 130 according to the test case (e.g., test procedures, test contents, etc.) by communicating with the test device 130. In addition, the control management unit 220 may collect data (e.g., sensing data) from the test device 130 and may process collected data.

The control management unit 220 may store a log of the test device 130, a scenario according to the test case, etc., and may maintain an error state that occurs during the test.

The service management unit 230 may store an application APP for the test device 130. For example, the service management unit 230 may store the application APP developed by a developer. The service management unit 230 may provide an application searching function to at least one selected from the test device 130 and the user USER. For example, the service management unit 230 may search the application that can use functions of the test device 130 based on the ID of the test device 130 and may provide a list of the searched application APP to the test device 130.

Although components of the test server 120 are named as the device management unit 210, the control management unit 220, and the service management unit 230, the components of the test server 120 are not limited to those names. For example, the device management unit 210 may be implemented in various forms such as a combination of hardware and a software platform, a library, a software solution, a software package, a software framework, a software, etc.

As described with reference to FIG. 2, the test server 120 may store the device information of the test device 130 and may provide a searching function for the test device 130. In addition, the test server 120 may create the virtual machine, may provide the control command to the test device 130, and may collect data generated by the test device 130. In addition, the test server 120 may store the application and may provide a searching function for the application.

Except the control management unit 220, the main server 110 may be substantially identical or similar to the test server 120. The main server 110 may store the device information of the test device 130 provided from the test server 120, may provide the searching function for the test device 130 to the test server 120, may store the application, and may provide the application and the searching function for the application to the test server 120 and the test device 130.

The test device 130 may be interconnected (or, associated) with the virtual machine that is created by the test server 120 and may assist in performing a test on the test target by interacting with other test devices. For example, when the test device 130 is selected by the test server 120 based on configuration information of the test case, the test device 130 may operate based on a command provided from the virtual machine of the test server 120. In addition, the test device 130 may perform a resource sharing (or, a device sharing) with the test server 120. For example, when the resources of the test server 120 is deficient to perform the test on the test target using the test case, the test device 130 may be set as a slave of the test server 120 according to controls of the test server 120. For example, the resources of the test device 130 may be shared to the test server 120.

The test device 130 may include a sensor and an embedded module. The sensor may directly collect data from a data source. The embedded module may process collected data.

In an example embodiment, the embedded module may include resources such as a central processing unit (CPU), a memory device, etc., and an operating system (OS). Here, the operating system may be Linux that is an open-source operating system. In example embodiments, at least a portion of the test devices D111 through D14N illustrated in FIG. 1 may include Linux and the operating system. Thus, at least a portion of the test devices D111 through D14N may perform a test instead of the test server 120 or may support the test server 120.

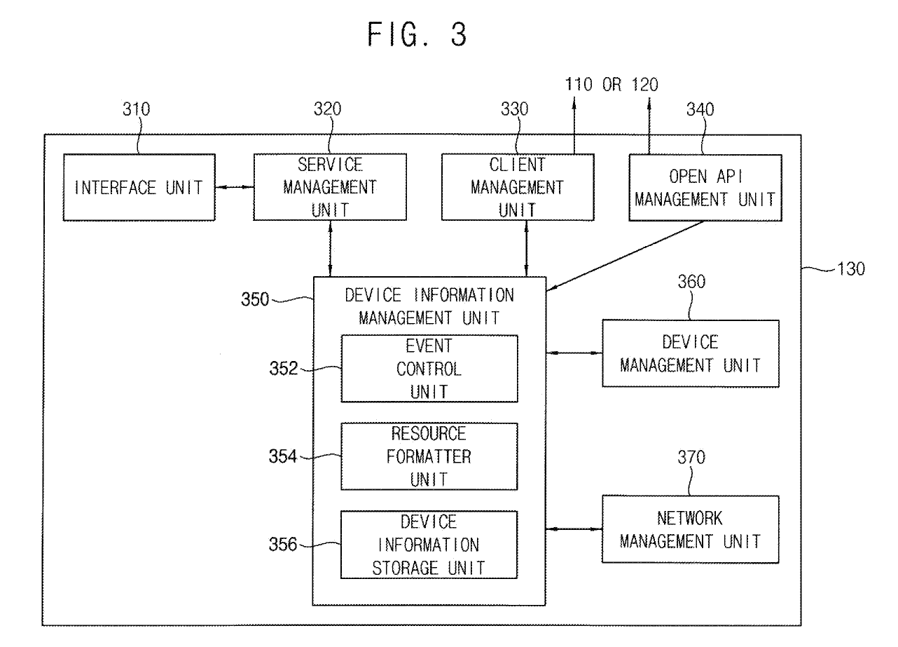

FIG. 3 is a block diagram illustrating an example of a test device included in the IoT framework of FIG. 1.

Referring to FIG. 3, the test device 130 may include an interface unit 310, a service management unit 320, a client management unit 330, an open API management unit 340, a device information management unit 350, a device management unit 360, and a network management unit 370.

The interface unit 310 may perform an interface function to allow the test device 130 to communicate with the test server 120. The interface unit 310 may transmit sensing data (e.g., sensing information obtained by the sensor of the test device 130), the device information of the test device 130, etc., to the service management unit 320 or may receive the control command from the service management unit 320. The interface unit 310 may perform the interface function using an application programming interface (API).

The service management unit 320 may manage a service that is provided from a device adapter. The service management unit 320 may transfer the device information of the test device 130 to the device information management unit 350. The service management unit 320 may periodically extract data generated by the test device 130 and may transfer the data to the device information management unit 350.

The service management unit 320 may transfer the control command received from the device information management unit 350 to the test server 120 through the interface unit 310.

The client management unit 330 may transfer the device information of the test device 130 that is a client to the test server 120 or the main server 110 and may update the data generated by the test device 130.

The client management unit 330 may register the test device 130 in the IoT framework by transferring the device information received from the device information management unit 350 to the test server 120 or the main server 110.

The open API management unit 340 may receive the data and the control command from the test server 120 through the open API and may transfer the data and the control command to the device information management unit 350. The open API management unit 340 may receive the control command from the test server 120 through the open API and may transfer the control command to the device information management unit 350. Thus, the open API management unit 340 (i.e., the test device 130) may receive the control command from the test server 120.

In addition, the open API management unit 340 may be directly connected to other external devices. Thus, the open API management unit 340 may receive the control command and may transmit the data. In this case, the external devices may directly communicate with the test device 130 by being connected in a Peer-to-Peer (P2P) manner. In addition, the open API management unit 340 may receive the control command through the P2P open API.

The device information management unit 350 may store and transfer the control command, the data, and the device information of the test device 130. As illustrated in FIG. 3, the device information management unit 350 may include an event control unit 352, a resource formatter unit 354, and a device information storage unit 356.

The event control unit 352 may generate an event for various operations of the device information management unit 350. For example, the event control unit 352 may generate (or, output) a first event to the client management unit 330 when the data, the change in the device information, or the device information from the service management unit 320 are stored in the device information storage unit 356. When the first event is generated, the client management unit 330 may receive (or, withdraw) and process the data or the device information stored in the device information storage unit 356. In addition, the event control unit 352 may generate (or, output) a second event to the service management unit 320 when the data or the control command from the open API management unit 340 are stored in the device information storage unit 356. When the second event is generated, the service management unit 320 may receive (or, withdraw) and process the data or the control command stored in the device information storage unit 356.

The resource formatter unit 354 may convert the data or the device information received from the service management unit 320 into data having a format suitable for being processed by the client management unit 330. In addition, the resource formatter unit 354 may convert the data or the control command received from the open API management unit 340 into data having a format suitable for being processed by the service management unit 320. For example, the resource formatter unit 354 may convert the device information, the data, and the control command into data having a format suitable for internal storage, information exchange between internal management units, and information exchange with external platforms.

The device information storage unit 356 may store and manage the device information, the control command, and the data in a device information base (DIB) manner. The device information management unit 350 may store the control command, the data, and the device information of the test device 130 and may transfer the control command, the data, and the device information of the test device 130 among the service management unit 320, the client management unit 330, and the open API management unit 340.

The device management unit 360 may manage security information of the test device 130 and basic controls. For example, the device management unit 360 may manage a security algorithm and an authentication key of the test device 130. For example, the device management unit 360 may control a system reset, a pause, a restart of the test device 130 and may perform a firmware version management and an update management.

The network management unit 370 may manage a network for communicating with the IoT framework 100. Here, the network may include a mobile communication network such as a 3G-network, a 4G-network, an SMS network, etc., and/or a wire/wireless network such as a wireless LAN network, a WIFI network (i.e., wireless communication network based on the IEEE 802.11 standards), an Ethernet network, etc.

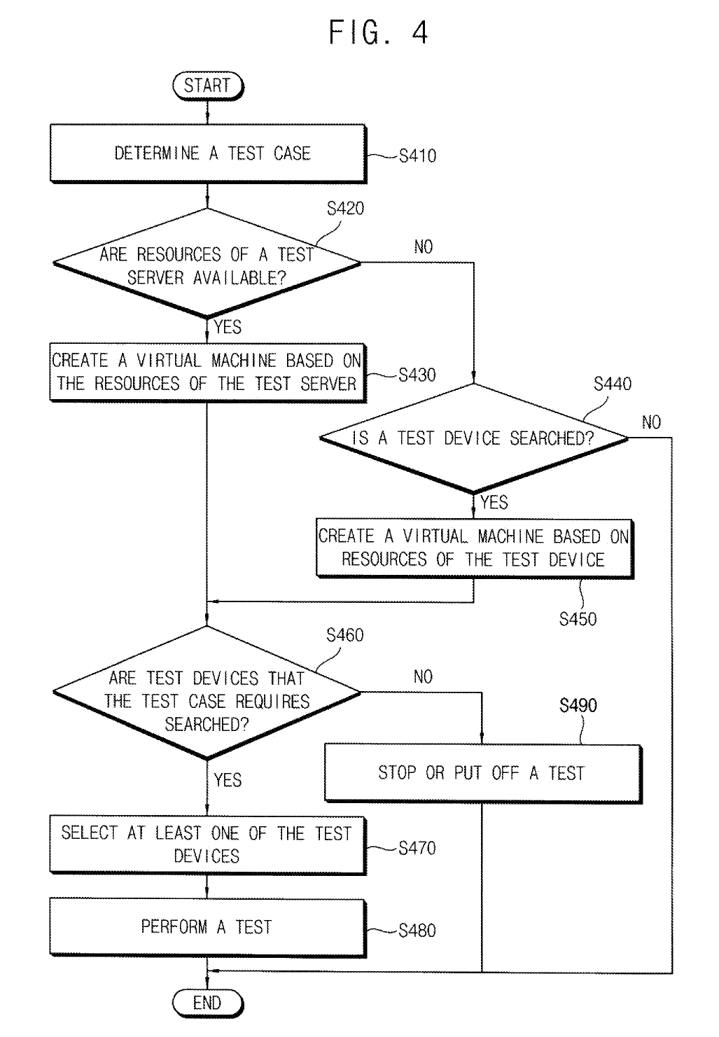

FIG. 4 is a flowchart illustrating a method of operating an IoT framework according to example embodiments.

Referring to FIGS. 1 and 4, the method of FIG. 4 may operate the IoT framework 100 of FIG. 1. Hereinafter, the method of FIG. 4 will be described by assuming a case in which a test is performed using the first test server 120-1 illustrated in FIG. 1.

The method of FIG. 4 may select or determine one test case among test cases (S410) for performing a test on the test target. Here, the method of FIG. 4 may determine one test case among the test cases based on predetermined test case selection criteria. As described above, the test cases may be variously set based on performance, function, etc., required for the test target. For example, the test cases may include a first test case for an interoperability test and a second test case for a conformance test. In this case, the method of FIG. 4 may select the first test case. For example, under the test case selection criteria, a test for a normal situation may be prioritized more than a test for an abnormal situation. Thus, between the first test case and the second test case, the method of FIG. 4 may select the first test case based on the test case selection criteria.

The method of FIG. 4 may create a virtual machine for performing the test case based on at least some of the resources of the first test server 120-1 and the resources of the first test device group 130-1.

The method of FIG. 4 may check whether the resources of the first test server 120-1 for the test case are available (S420). For example, the method of FIG. 4 may check whether the resources of the first test server 120-1 are sufficient to perform the test on the test target using the test case based on a state of the first test server 120-1. Here, the test case may be one test case selected among the test cases.

For example, the test case may include test description of test requirements. The test description may include applicability information that includes features and functions required for performing the test, configuration (or, architecture) information that includes configurations of the test devices required for performing the test, pre-test conditions information that includes conditions required to be set before performing the test, and test sequence information that includes contents required to be checked in each step (or, each phase) and sequences required to be followed while performing the test. In this case, the method of FIG. 4 may calculate or determine resources required for performing the test on the test target using the test case based on the test description (e.g., the applicability information, the configuration information, and the test sequence information) of the test case. For another example, the test description may include requirement resource information indicating the resources required for performing the test on the test target using the test case. In this case, the method of FIG. 4 may compare the requirement resource information with a state of the resources of the first test server 120-1 (e.g., available resources).

When the resources of the first test server 120-1 are available, the method of FIG. 4 may create the virtual machine based on the resources of the first test server 120-1 (S430) and may allocate the resources of the first test server 120-1 to the virtual machine. For example, when the resources of the first test server 120-1 are determined to be sufficient for performing the test on the test target using the test case, the method of FIG. 4 may create the virtual machine based on the resources of the first test server 120-1.

When the resources of the first test server 120-1 are not available, the method of FIG. 4 may search at least one test device in the IoT framework 100 (S440). For example, when the resources of the first test server 120-1 are determined to be insufficient for performing the test on the test target using the test case, the method of FIG. 4 may search at least one test device in the IoT framework 100. Here, at least one test device (e.g., the (1)st test device D111) may be a test device having resources, which may replace the first test server 120-1 or may support the first test server 120-1.

In an example embodiment, the method of FIG. 4 may search at least one test device based on device information of the (1)st through (N)th test devices D111 through D11N stored in the first test server 120-1 and requirement resource information of the test case.

As described with reference to FIG. 2, the device information of the (1)st through (N)th test devices D111 through D11N may be stored in the device management unit 210 of the test server 120 which is substantially similar to the first test server 120-1. In addition, the device information of the (1)st through (N)th test devices D111 through D11N may include IDs of the (1)st through (N)th test devices D111 through D11N, location information, device state information, resource information, application information (e.g., information of application installed in the test device), etc. In this case, the method of FIG. 1 may search at least one test device among the (1)st through (N)th test devices D111 through D11N based on the device state information and the resource information.

For example, the method of FIG. 4 may search a test device that satisfies a first condition in the first test device group 130-1. Here, the first condition may include a condition in which the state of the test device is a non-operating state and a condition in which the test device includes resources available for the test case. For example, the method of FIG. 4 may search at least one test device of which the device state information indicates the non-operating state (e.g., a hibernation state), which includes more resources than resources required for performing the test on the test target using the test case.

Subsequently, the method of FIG. 4 may determine priorities of the (1)st through (N)th test devices D111 through D11N based on the device information of the (1)st through (N)th test devices D111 through D11N and the requirement resource information of the test case and may select the test device based on the first condition and the priorities of the (1)st through (N)th test devices D111 through D11N. For example, the method of FIG. 4 may determine the priority of the test device having sufficient resources to be relatively high. In this exemplary embodiment, the method of FIG. 4 may select the test device having the highest priority among searched test devices. Meanwhile, the method of FIG. 4 may store the determined priorities of the first test devices 130-1 and the device information in the first test server 120-1. Similarly, the method of FIG. 4 may store the determined priorities of the first test devices 130-1 and the device information in the main server 110.

In an example embodiment, when the test device is not searched in the first test system FARM1 including the first test server 120-1, the method of FIG. 4 may search at least one test device in the second test system FARM2 that is different from the first test system FARM1. In addition, the method of FIG. 4 may search at least one test device in the third test system FARM3. For example, the method of FIG. 4 may search at least one test device in the IoT framework 100 other than the first test system FARM1.

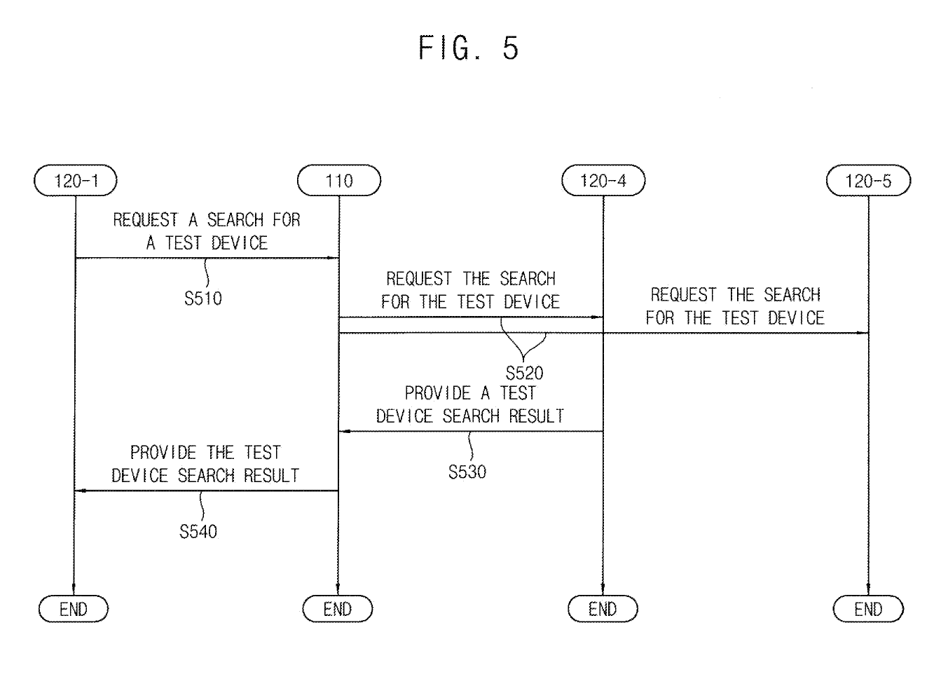

For example, the method of FIG. 4 may search the test device based on the device information of the test devices included in the main server 110 (i.e., the (1)st through (4N)th test devices D111 through D14N). For example, the method of FIG. 4 may search at least one test device included in the second test system FARM2 by using a test device searching function provided by the main server 110. Hereinafter, a configuration for searching the test device will be described with reference to FIG. 5, and then the steps S450 through S490 will be described.

FIG. 5 is a flowchart illustrating an example in which a test device is searched by the method of FIG. 4.

Referring to FIGS. 4 and 5, the first test server 120-1 may request a search for the test device to the main server 110 (S510). For example, the first test server 120-1 may request the search for the test device along with the test description of the test case (e.g., the requirement resource information included in the test description) to the main server 110. In this case, the main server 110 may search at least one test device based on the information of the test devices D111 through D14N, which is stored in the device management unit 210.

In contrast, the main server 110 may request a search for the test device to the second test server 120-2 and the third test server 120-3 (S520). For example, the main server 110 may transfer a search request for the test device received from the first test server 120-1 to the second test server 120-2 and the third test server 120-3. The main server 110 may collect (or, perform a crawling) the information of the test device periodically or whenever a specific event occurs. Here, the specific event may include an additional registration, a change, a discard, etc., of the test devices D111 through D14N. The main server 110 may request a search for the test device to the second test server 120-2 and the third test server 120-3 in view of a case in which the main server 110 periodically collects the information of the test devices D111 through D14N.

In this case, the second test server 120-2 may search the test device corresponding to the requirement resource information based on the information of the (21)st through (2N)th test devices D121 through D12N, which is stored in the device management unit 210 of the second test server 120-2. Similarly, the third test server 120-3 may search the test device corresponding to the requirement resource information.

Subsequently, the second test server 120-2 that includes the test device corresponding to the requirement resource information may provide a test device search result to the main server 110 (S530). For example, when the second test server 120-2 includes the test device corresponding to the requirement resource information, the second test server 120-2 may provide the test device search result to the main server 110. The main server 110 may provide the test device search result received from the second test server 120-2 to the first test server 120-1 (S540).

Although it is illustrated in FIG. 5 that only the second test server 120-2 provides the test device search result to the main server 110, the present inventive concept is not limited thereto. For example, the third test server 120-3 or the fourth test server 120-4 may provide the test device search result to the main server 110. For example, the main server 110 may provide a second test device search result received from the second test server 120-2 and a third test device search result received from the third test server 120-3 to the first test server 120-1. For another example, the main server 110 may provide the second test device search result received from the second test server 120-2 or the third test device search result received from the third test server 120-3 to the first test server 120-1.

Referring back to FIG. 4, when at least one test device (e.g., the (1)st test device D111) is searched, the method of FIG. 4 may create a virtual machine in the at least one test device (S450). For example, the method of FIG. 4 may select one test device among the searched test devices and may create the virtual machine in the selected test device based on resources of the selected test device. For example, the method of FIG. 4 may set the selected test device to be a slave of the first test server 120-1 and may create the virtual machine based on the resources of the test device. For example, the method of FIG. 4 may set or control the resources of the test device to be shared with the first test server 120-1 (i.e., may perform a resource sharing). Here, the device state information of the selected test device may indicate that a state of the selected test device is changed from a non-operating state to an operating (i.e., busy) state.

The method of FIG. 4 may search at least one test device that the test case requires in the first test system FARM1 (S460). For example, the method of FIG. 4 may search at least one test device based on the configuration information included in the test description of the test case (i.e., the information relating to configurations of the test devices required for performing the test) and the information of the (1)st through (N)th test devices D111 through D11N (e.g., the device state information of the (1)st through (N)th test devices D111 through D11N). For example, the method of FIG. 4 may search at least one test device (e.g., the (2)nd test device D112) of which the device state information indicates the non-operating state, which is included in the configuration information of the test description of the test case.

Subsequently, the method of FIG. 4 may select at least one test device that the test case requires among the searched test devices (S470) and may perform the test included in the test case using the selected test device (S480).

In an example embodiment, when the test device that the test case requires is not searched in the first test system FARM1, the method of FIG. 4 may search the test device that the test case requires in the second test system FARM2. Since a process in which the test device is searched in the second test system FARM2 is substantially the same as a process described with reference to FIGS. 4 and 5, the duplicated description will not be repeated.

When the test device that the test case requires is not searched in the first and second test systems FARM1 and FARM2, the method of FIG. 4 may stop or put off a process for the test case (S490).

As described above, the method of FIG. 4 may improve efficiency of the IoT framework by performing the test based on the resources of the test device (e.g., one test device selected among the (1)st through (N)th test devices D111 through D11N) as well as the resources of the first test server 120-1. In addition, the method of FIG. 4 may reduce a verification time for IoT products by performing the test for the IoT products using the test device groups located in different physical regions, which are connected to the main server 110 (e.g., the second test device group 130-2 and the third test device group 130-3), as well as the test devices connected to a local network (e.g., the first test device group 130-1 connected to the first test server 120-1 in the local network).

In an example embodiment, the method of FIG. 4 may be performed in real-time. In another example embodiment, the method of FIG. 4 may be performed based on scheduling. For example, the method of FIG. 4 may determine a time when the test case is performed while determining the test case. For example, the test case may include time information indicating a time when the test is performed. In this exemplary embodiment, the method of FIG. 4 may check whether the resources of the first test server 120-1 are available based on the time information. Similarly, the method of FIG. 4 may search the test device based on the time information and the state of the test devices D111 through D14N.

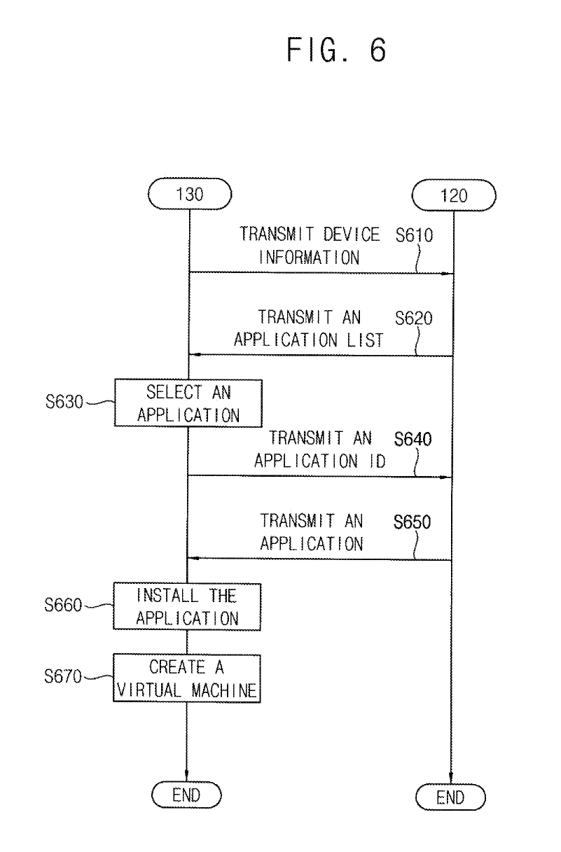

FIG. 6 is a flowchart illustrating an example in which a virtual machine is created in a test device by the method of FIG. 4.

Referring to FIGS. 4 and 6, the method of FIG. 4 may select a test device (e.g., the (1)st test device D111) in which an application relating to a virtual machine creation is not installed.

In this case, the test device may transmit device information to the first test server 120-1 or the main server 110 (S610). For example, the test device may transmit an ID of the test device to the first test server 120-1.

The first test server 120-1 may transmit an application list relating to the device information of the test device to the test device (S620). For example, the first test server 120-1 may return (or, reply) an application list that includes applications that can be used for creating a virtual machine and can be installed in the test device among applications stored in the service management unit 230 to the test device.

The test device may select a specific application among the applications included in the application list received from the first test server 120-1 (S630). For example, the test device may select the specific application based on application selection criteria. For example, the test device may select the specific application by considering an application made by a manufacturer that manufactures the test device, an application that is downloaded many times, etc.

The test device may transmit an application ID matched to the selected application to the first test server 120-1 (S640). The first test server 120-1 may transmit an application matched to the application ID to the test device (S650).

In this exemplary embodiment, the test device may install the received application (S660) and may create the virtual machine based on the application (S670).

Although it is illustrated in FIG. 6 that the test device transmits the device information and the first test server 120-1 returns the application list, the present inventive concept is not limited thereto. For example, the first test server 120-1 may select the test device to create the virtual machine, may select the application that can be installed in the test device based on device information stored in a device management unit of the first test server 120-1, and then may transmit the selected application to the test device.

Embodiments of the present inventive concept may be applied to a test device for a semiconductor memory device. For example, embodiments of the present inventive concept may be applied to a test system for an IoT device including the semiconductor memory device.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of operating an internet of things (IoT) system that includes a first test system including a first test server and a first test device group, a second test system including a second test server and a second test device group, and a main server, where the first test system, the second test system, and the main server are connected through a network, the method comprising:
creating a virtual machine for performing a test on a test target using a test case based on at least a portion of resources of the first test device group and resources of the first test server;
selecting at least one test device among the first test device group and the second test device group;
connecting the at least one test device to the virtual machine; and
performing the test on the test target using the virtual machine and the at least one test device.

2. The method of claim 1, wherein creating the virtual machine includes:
checking whether the resources of the first test server for the test case are available;
searching a test device that satisfies a first condition among the first test device group when the resources of the first test server are not available; and
creating the virtual machine based on resources of the test device that satisfies the first condition when the test device that satisfies the first condition is searched,
wherein the test device that satisfies the first condition has a non-operating state and includes the resources that are available for the test case.

3. The method of claim 2, wherein checking whether the resources of the first test server are available includes:
determining that the resources of the first test server are not available when the resources of the first test server are insufficient to perform the test on the test target using the test case or when an error occurs in the first test server.

4. The method of claim 2, wherein searching the test device that satisfies the first condition includes:
determining priorities of (1)st through (N)th test devices included in the first test device group, where N is an integer greater than or equal to 2, based on device information of the (1)st through (N)th test devices and requirement resource information of the test case; and
selecting the test device that satisfies the first condition based on the first condition and the priorities of the (1)st through (N)th test devices,
wherein the device information includes device state information relating to states of the (1)st through (N)th test devices, resource information relating to resources of the (1)st through (N)th test devices, and application information relating to applications installed in the (1)st through (N)th test devices.

5. The method of claim 4, wherein the priorities of the (1)st through (N)th test devices are set to be higher as a size of the resources of the (1)st through (N)th test devices increases, and
wherein selecting the test device that satisfies the first condition based on the first condition and the priorities of the (1)st through (N)th test devices includes:
selecting the test device that has the highest priority and satisfies the first condition.

6. The method of claim 4, wherein determining the priorities of the (1)st through (N)th test devices includes:
storing the priorities of the (1)st through (N)th test devices along with the device information in the main server.

7. The method of claim 2, wherein searching the test device that satisfies the first condition further includes:
when none of the test devices among the first test device group satisfies the first condition, searching the test device that satisfies the first condition in the second test system.

8. The method of claim 7, wherein searching the test device that satisfies the first condition in the second test system includes:
requesting, at the first test server, a search for the test device to the main server; and
searching the test device that satisfies the first condition based on device information of (21)st through (2N)th test devices included in the second test device group stored in the main server.

9. The method of claim 7, wherein searching the test device that satisfies the first condition in the second test system includes:
requesting, at the first test server, a search for the at least one test device to the main server;
requesting, at the main server, the search for the at least one test device to the second test server;
transmitting, at the second test server, a test device search result to the main server; and
transmitting, at the main server, the test device search result to the first test server.

10. The method of claim 2, wherein creating the virtual machine based on the resources of the test device that satisfies the first condition includes:
transmitting, at the test device that satisfies the first condition, device information of the test device that satisfies the first condition to the test server;
transmitting, at the test server, an application list relating to the test device that satisfies the first condition to the test device that satisfies the first condition;
selecting an application included in the application list based on selection criteria;
transmitting, at the test device that satisfies the first condition, an application ID matched to the application included in the application list to the test server; and
transmitting, at the test server, an application matched to the application ID to the test device that satisfies the first condition.

11. The method of claim 10, wherein the application list includes at least one application capable of being installed in the test device that satisfies the first condition among applications stored in the first test server, and
wherein selecting the application included in the application list includes:
selecting the application included in the application list, which is capable of being installed in the test device that satisfies the first condition, based on a manufacturer that manufactures the application and a number of times that the application is being downloaded.

12. The method of claim 1, wherein selecting the at least one test device includes:
searching the at least one test device among the first test device group; and
searching the at least one test device among the second test device group when the at least one test device is not searched among the first test device group.

13. The method of claim 1, wherein the test case further includes time information relating to a time when the test on the test target using the test case is being performed,
wherein creating the virtual machine includes:
checking whether the resources of the first test server for the test case are available based on the time information; and
searching a test device that satisfies a second condition among the first test device group when the resources of the first test server are not available, and
wherein the test device that satisfies the second condition has a non-operating state at a time indicated by the time information and includes resources that are available for the test case.

14. An internet of things (IoT) system comprising:
a first test system including a first test server and a first test device group, the first test server and the first test device group being connected through a first local network;
a second test system including a second test server and a second test device group, the second test server and the second test device group being connected through a second local network; and
a main server connected to the first test system and the second test system through a network and configured to manage device information of test devices included in the first test device group and the second test device group,
wherein the first test server creates a virtual machine based on at least a portion of resources of the test devices, selects at least one test device based on the device information of the test devices, and performs a test on a test target using a test case by interconnecting the test target with the at least one test device through the virtual machine.

15. The system of claim 14, wherein the first test server searches a test device that satisfies a first condition among the test devices,
wherein the first test server creates the virtual machine based on resources of the test device that satisfies the first condition when the test device that satisfies the first condition is searched, and
wherein the test device that satisfies the first condition has a non-operating state and includes the resources that are available for the test case.

16. A method of operating an internet of things (IoT) system comprising:
providing a first test system including a first sub server and a first test device group, and connecting the first sub server and the first test device group through a first local network;
providing a second test system including a second sub server and a second test device group, and connecting the second sub server and the second test device group through a second local network different from the first local network; and
connecting a main server to the first test system and the second test system through a network, the main server managing device information of test devices included in the first test device group and the second test device group;
creating a virtual machine based on at least a portion of resources of the test devices and resources of the first sub server;
selecting at least one test device based on the device information of the test devices; and
performing a test on a test target by interconnecting the test target with the at least one test device through the virtual machine.

17. The method of 16, wherein the performing the test on the test target includes:
performing a test on the test target using a test case, wherein the test case is set based on standard or performance characteristics required for the test target.

18. The method of claim 17, wherein the test case includes test procedures or test contents and performing the test on the test target includes:
interconnecting the test target with the at least one test device; and
monitoring an operation of the test target based on the test procedures or the test contents.

19. The method of claim 17, wherein creating the virtual machine includes:
checking whether resources of the first sub server for the test case are available;
searching a test device that satisfies a first condition among the first test device group when the resources of the first sub server are not available; and
creating the virtual machine based on resources of the test device that satisfies the first condition when the test device that satisfies the first condition is searched,
wherein the test device that satisfies the first condition has a non-operating state and includes the resources that are available for the test case.

20. The method of claim 19, wherein checking whether resources of the first sub server are available includes:
determining that the resources of the first sub server are not available when the resources of the first sub server are insufficient to perform the test on the test target using the test case or when an error occurs in the first sub server.
